(19) United States
(12) Patent Application Publication
(10) Pub. No.: US 2012/0331536 A1
(43) Pub. Date: Dec. 27, 2012

(54) SEAMLESS SIGN-ON COMBINED WITH AN IDENTITY CONFIRMATION PROCEDURE

(75) Inventors: Harsimranjit Chabbewal, San Francisco, CA (US); William Charles Mortimore, JR., San Francisco, CA (US); Alan Vangpat, Pittsburgh, PA (US)

(73) Assignee: SALESFORCE.COM, INC., San Francisco, CA (US)

(21) Appl. No.: 13/279,948

(22) Filed: Oct. 24, 2011

Related U.S. Application Data
(60) Provisional application No. 61/500,422, filed on Jun. 23, 2011.

(51) Int. Cl. H04L 9/32; G06F 21/20

(52) U.S. Cl. 726/7; 726/3

(57) ABSTRACT

A method executable by a server system confirms the identity of a user of a client device. The method receives an activation request from the client device and maintains information corresponding to a destination resource requested by the client device. In response to receiving the activation request, the server system sends a code to a registered device of the user. After sending the code, the server system receives a verification request from the client device. The verification request includes a user-entered representation of the code. In response to receiving the verification request the client device is activated as a new registered device for the user, and the server system seamlessly provides the destination resource to the client device using the maintained information.

### CROSS-REFERENCE TO RELATED APPLICATION(S)

This application claims the benefit of U.S. provisional patent application Ser. No. 61/500,422, filed Jun. 23, 2011, the content of which is incorporated by reference herein.

### TECHNICAL FIELD

Embodiments of the subject matter described herein relate generally to data processing systems and techniques, such as systems and processes that use a common network-based platform to support applications executing on behalf of multiple tenants. More particularly, embodiments of the subject matter relate to techniques, protocols, and methodologies for confirming the identity of a user attempting to gain access to a resource using an unknown or unregistered device.

### BACKGROUND

Modern software development is evolving away from the client-server model toward network-based processing systems that provide access to data and services via the Internet or other networks. In contrast to traditional systems that host networked applications on dedicated server hardware, a “cloud” computing model allows applications to be provided over the network “as a service” supplied by an infrastructure provider. The infrastructure provider typically abstracts the underlying hardware and other resources used to deliver a customer-developed application so that the customer no longer needs to operate and support dedicated server hardware. The cloud computing model can often provide substantial cost savings to the customer over the life of the application because the customer no longer needs to provide dedicated network infrastructure, electrical and temperature controls, physical security and other logistics in support of dedicated server hardware.

Multi-tenant cloud-based architectures have been developed to improve collaboration, integration, and community-based cooperation between customer tenants without sacrificing data security. Generally speaking, multi-tenancy refers to a system wherein a single hardware and software platform simultaneously supports multiple user groups (also referred to as “organizations” or “tenants”) from a common data store. The multi-tenant design provides a number of advantages over conventional server virtualization systems. First, the multi-tenant platform operator can often make improvements to the platform based upon collective information from the entire tenant community. Additionally, because all users in the multi-tenant environment execute applications within a common processing space, it is relatively easy to grant or deny access to specific sets of data for any user within the multi-tenant platform, thereby improving collaboration and integration between applications and the data managed by the various applications. The multi-tenant architecture therefore allows convenient and cost effective sharing of similar application features between multiple sets of users.

In certain situations, it may be necessary or desirable to grant access to secure data, a secure application, protected web pages, or other secure resources. In such situations, user credentials (e.g., a username and password) are typically utilized to gain access to the secure information. An identity confirmation procedure may also be implemented in addition to conventional user authentication methodologies. In this regard, an identity confirmation routine may be initiated when a user enters his or her credentials using a device (such as a computer, a smartphone, or a mobile device) that is not recognized by the authenticating system. For example, if a legitimate and authorized user has never logged in from his personal laptop computer, then an identity confirmation routine may be invoked to confirm the user's identity and to activate or register his laptop computer as a verified and usable device.

After successful confirmation of a user's identity, the user will typically be required to enter the credentials once again before gaining access to the desired information. In other words, the identity confirmation procedure may ultimately lead to a “dead end” in the intended application, resulting in an interruption in the user's workflow and a frustrating user experience. Accordingly, it would be desirable to have a seamless sign-on routine that is combined with an identity confirmation procedure.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a block diagram of an exemplary multi-tenant data processing system;

FIG. 2 is a block diagram that illustrates an exemplary server system suitable for use in performing user authentication and identity confirmation processes;

FIG. 3 is a diagram that depicts an exemplary identity confirmation flow that involves a server system, a registered client device, and a nonregistered client device;

FIG. 4 depicts an exemplary activation screen that may be generated during the flow depicted in FIG. 3 and/or during the process depicted in FIG. 6;

FIG. 5 depicts an exemplary verification screen that may be generated during the flow depicted in FIG. 3 and/or during the process depicted in FIG. 6; and

FIG. 6 is a flow chart that illustrates an exemplary embodiment of an identity confirmation process.

### DETAILED DESCRIPTION

The exemplary embodiments presented here relate to various user authentication and identity confirmation techniques, protocols, procedures, and technology. The described subject matter can implemented in the context of any computer-implemented system, such as a software-based system, a database system, a multi-tenant environment, or the like. Moreover, the described subject matter could be implemented in connection with two or more separate and distinct computer-implemented systems that cooperate and communicate with one another.

In accordance with one exemplary embodiment described below, a client device that is being used to enter user credentials to access secure information (such as a web page of a cloud-based application) can be activated or registered as a verified user device using an identity confirmation routine that also seamlessly authenticates the user and provides access to the desired information in a manner that is transparent to the user. In other words, the previously unrecognized client device is activated for the user, the user is authenticated, and the user is given access to the secure destination in a simplified fashion with little to no user involvement other than the entry of a verification code that is sent to a previously registered device of the user.

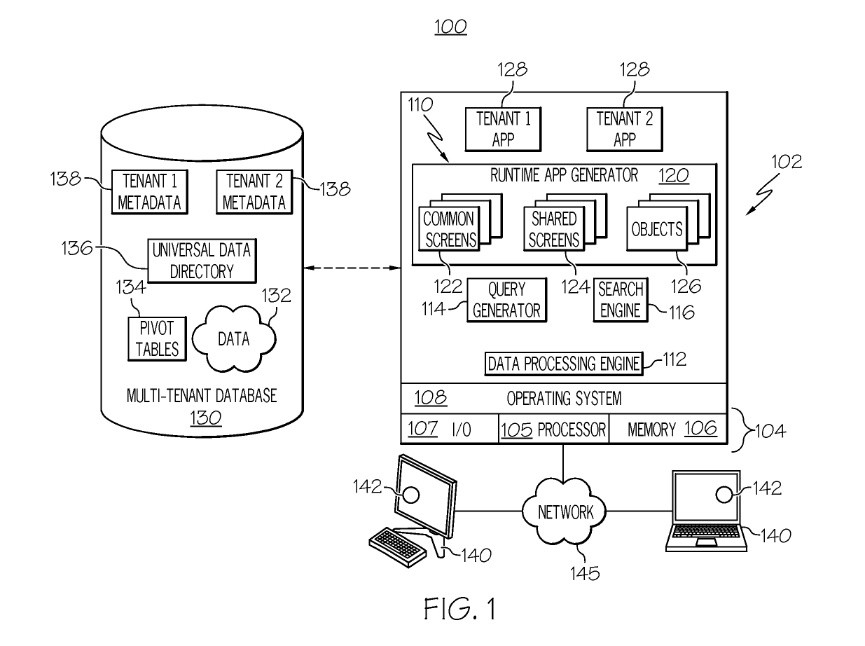

Turning now to FIG. 1, an exemplary multi-tenant application system 100 suitably includes a server 102 that dynamically creates virtual applications 128 based upon data 132 from a common database 130 that is shared between multiple tenants. Data and services generated by the virtual applications 128 are provided via a network 145 to any number of user devices 140, as desired. Each virtual application 128 is suitably generated at run-time using a common application platform 110 that securely provides access to the data 132 in the database 130 for each of the various tenants subscribing to the system 100. In accordance with one non-limiting example, the system 100 may be implemented in the form of a multi-tenant customer relationship management system that can support any number of authenticated users of multiple tenants.

A “tenant” or an “organization” generally refers to a group of users that shares access to common data within the database 130. Tenants may represent customers, customer departments, business or legal organizations, and/or any other entities that maintain data for particular sets of users within the system 100. Although multiple tenants may share access to the server 102 and the database 130, the particular data and services provided from the server 102 to each tenant can be securely isolated from those provided to other tenants. The multi-tenant architecture therefore allows different sets of users to share functionality without necessarily sharing any of the data 132.

The database 130 is any sort of repository or other data storage system capable of storing and managing the data 132 associated with any number of tenants. The database 130 may be implemented using any type of conventional database server hardware. In various embodiments, the database 130 shares processing hardware 104 with the server 102. In other embodiments, the database 130 is implemented using separate physical and/or virtual database server hardware that communicates with the server 102 to perform the various functions described herein.

The data 132 may be organized and formatted in any manner to support the application platform 110. In various embodiments, the data 132 is suitably organized into a relatively small number of large data tables to maintain a semi-amorphous “heap”-type format. The data 132 can then be organized as needed for a particular virtual application 128. In various embodiments, conventional data relationships are established using any number of pivot tables 134 that establish indexing, uniqueness, relationships between entities, and/or other aspects of conventional database organization as desired.

Further data manipulation and report formatting is generally performed at run-time using a variety of metadata constructs. Metadata within a universal data directory (UDD) 136, for example, can be used to describe any number of forms, reports, workflows, user access privileges, business logic and other constructs that are common to multiple tenants. Tenant-specific formatting, functions and other constructs may be maintained as tenant-specific metadata 138 for each tenant, as desired. Rather than forcing the data 132 into an inflexible global structure that is common to all tenants and applications, the database 130 is organized to be relatively amorphous, with the pivot tables 134 and the metadata 138 providing additional structure on an as-needed basis. To that end, the application platform 110 suitably uses the pivot tables 134 and/or the metadata 138 to generate “virtual” components of the virtual applications 128 to logically obtain, process, and present the relatively amorphous data 132 from the database 130.

The server 102 is implemented using one or more actual and/or virtual computing systems that collectively provide the dynamic application platform 110 for generating the virtual applications 128. The server 102 operates with any sort of conventional processing hardware 104, such as a processor 105, memory 106, input/output features 107 and the like. The processor 105 may be implemented using one or more of microprocessors, microcontrollers, processing cores and/or other computing resources spread across any number of distributed or integrated systems, including any number of “cloud-based” or other virtual systems. The memory 106 represents any non-transitory short or long term storage capable of storing programming instructions for execution on the processor 105, including any sort of random access memory (RAM), read only memory (ROM), flash memory, magnetic or optical mass storage, and/or the like. The server 102 typically includes or cooperates with some type of computer-readable media, where a tangible computer-readable medium has computer-executable instructions stored thereon. The computer-executable instructions, when read and executed by the server 102, cause the server 102 to perform certain tasks, operations, functions, and processes described in more detail herein. In this regard, the memory 106 may represent one suitable implementation of such computer-readable media. Alternatively or additionally, the server 102 could receive and cooperate with computer-readable media (not separately shown) that is realized as a portable or mobile component or platform, e.g., a portable hard drive, a USB flash drive, an optical disc, or the like.

The input/output features 107 represent conventional interfaces to networks (e.g., to the network 145, or any other local area, wide area or other network), mass storage, display devices, data entry devices and/or the like. In a typical embodiment, the application platform 110 gains access to processing resources, communications interfaces and other features of the processing hardware 104 using any sort of conventional or proprietary operating system 108. As noted above, the server 102 may be implemented using a cluster of actual and/or virtual servers operating in conjunction with each other, typically in association with conventional network communications, cluster management, load balancing and other features as appropriate.

The application platform 110 is any sort of software application or other data processing engine that generates the virtual applications 128 that provide data and/or services to the user devices 140. The virtual applications 128 are typically generated at run-time in response to queries received from the user devices 140. For the illustrated embodiment, the application platform 110 includes a bulk data processing engine 112, a query generator 114, a search engine 116 that provides text indexing and other search functionality, and a runtime application generator 120. Each of these features may be implemented as a separate process or other module, and many equivalent embodiments could include different and/or additional features, components or other modules as desired.

The runtime application generator 120 dynamically builds and executes the virtual applications 128 in response to specific requests received from the user devices 140. The virtual applications 128 created by tenants are typically constructed in accordance with the tenant-specific metadata 138, which describes the particular tables, reports, interfaces and/or other features of the particular application. In various embodiments, each virtual application 128 generates dynamic web content that can be served to a browser or other client program 142 associated with its user device 140, as appropriate. As used herein, such web content represents one type of resource, data, or information that may be protected or secured using various user authentication procedures.

The runtime application generator 120 suitably interacts with the query generator 114 to efficiently obtain multi-tenant data 132 from the database 130 as needed. In a typical embodiment, the query generator 114 considers the identity of the user requesting a particular function, and then builds and executes queries to the database 130 using system-wide metadata 136, tenant specific metadata 138, pivot tables 134, and/or any other available resources. The query generator 114 in this example therefore maintains security of the common database 130 by ensuring that queries are consistent with access privileges granted to the user that initiated the request.

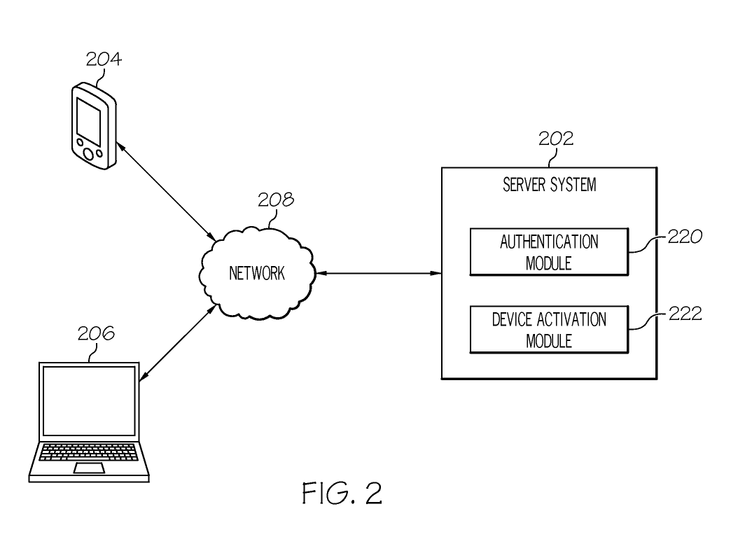

The data processing engine 112 performs bulk processing operations on the data 132 such as uploads or downloads, updates, online transaction processing, and/or the like. In many embodiments, less urgent bulk processing of the data 132 can be scheduled to occur as processing resources become available, thereby giving priority to more urgent data processing by the query generator 114, the search engine 116, the virtual applications 128, etc. In certain embodiments, the data processing engine 112 and the processor 105 cooperate in an appropriate manner to perform and manage the various user authentication, identity confirmation, security token processing, data access granting, and other techniques, processes, and methods described in more detail below with reference to FIGS. 2-6.

In operation, developers use the application platform 110 to create data-driven virtual applications 128 for the tenants that they support. Such virtual applications 128 may make use of interface features such as tenant-specific screens 124, universal screens 122 or the like. Any number of tenant-specific and/or universal objects 126 may also be available for integration into tenant-developed virtual applications 128. The data 132 associated with each virtual application 128 is provided to the database 130, as appropriate, and stored until it is requested or is otherwise needed, along with the metadata 138 that describes the particular features (e.g., reports, tables, functions, etc.) of that particular tenant-specific virtual application 128.

The data and services provided by the server 102 can be retrieved using any sort of personal computer, mobile telephone, portable device, tablet computer, or other network-enabled user device 140 that communicates via the network 145. Typically, the user operates a conventional browser or other client program 142 to contact the server 102 via the network 145 using, for example, the hypertext transport protocol (HTTP) or the like. The user typically authenticates his or her identity to the server 102 to obtain a session identifier (“SessionID”) that identifies the user in subsequent communications with the server 102. When the identified user requests access to a virtual application 128, the runtime application generator 120 suitably creates the application at run time based upon the metadata 138, as appropriate. The query generator 114 suitably obtains the requested data 132 from the database 130 as needed to populate the tables, reports or other features of the particular virtual application 128. As noted above, the virtual application 128 may contain Java, ActiveX, or other content that can be presented using conventional client software running on the user device 140; other embodiments may simply provide dynamic web or other content that can be presented and viewed by the user, as desired.

FIG. 2 is a block diagram that illustrates an exemplary server system 202 suitable for use in performing user authentication and identity confirmation processes. FIG. 2 depicts a simplified system environment that includes the server system 202 and two client devices 204, 206. Each of the client devices 204, 206 communicates with the server system 202 via a network 208. Referring again to FIG. 1, the server system 202 may be implemented in the server 102, the network 208 may have the characteristics and features of the network 145, and the client devices 204, 206 may be configured as described above for the user devices 140. Indeed, although not depicted in FIG. 2, the server system 202 could be deployed in the context of a multi-tenant application system, such as the system 100 described above. Moreover, FIG. 2 depicts functional modules of the server system 202 that might be realized using, for example, one or more processors, a data processing engine, or other computer-implemented logic resident at one or more physical pieces of hardware. In certain embodiments, the server system 202 is realized in a distributed manner using a plurality of computing devices that communicate with one another.

For this particular example, the client device 204 has already been registered or activated for the user. Thus, the server system 202 will recognize the client device 204 as a registered device when the user logs in using the client device 204. In contrast, the client device 206 is considered to be a “new” device for the user in that it has not been previously registered or activated for the user. Accordingly, the server system 202 will not recognize the client device 206 as a previously activated device when the user logs in for the first time using the client device 206.

The server system 202 may include an authentication module 220 and a device activation module 222 that cooperate to perform certain functions, tasks, and processes described in more detail herein. It should be appreciated that the authentication module 220 and the device activation module 222 may be realized as functional, logical, or processing modules of a piece of hardware; software-based applications that execute at a piece of hardware; or the like. The authentication module 220 is generally responsible for carrying out tasks and functions related to authentication of a user of the client devices 204, 206. For example, the authentication module 220 may be configured to check user credentials, generate security tokens that facilitate single sign-on and/or other login routines, provide access to resources and information upon successful user authentication, and the like. The device activation module 222 may be configured to activate a client device for the user (e.g., the client device 206) by sending a verification code to the user in the form of an email, text, voicemail, or other type of message. If the user correctly enters the verification code at the client device 206, the device activation module 222 will activate/register the client device 206 such that the server system 202 can proceed with a seamless and automatic user login from the client device 206.

The server system 202 can be utilized to perform a seamless single sign-on procedure that is combined with an identity confirmation procedure for the unregistered client device 206. In other words, the server system 202 is suitably configured to activate or register the client device 206 upon a successful completion of an identity confirmation challenge and immediately thereafter log the user in and direct the client device 206 to the desired destination resource (which is a web page in this example).

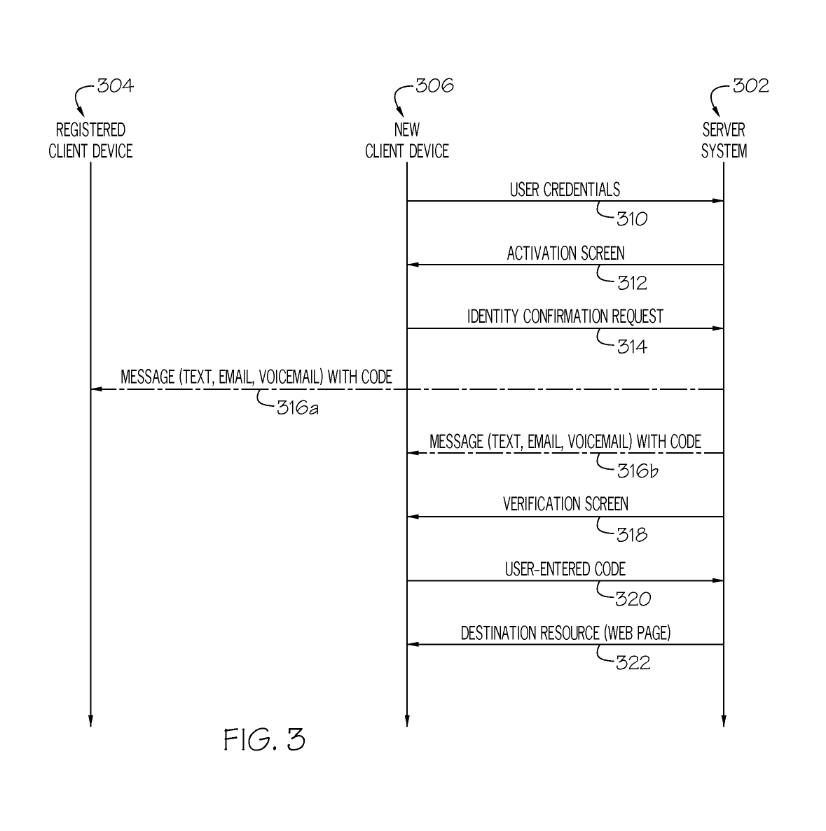

FIG. 3 is a diagram that depicts an exemplary identity confirmation flow that involves a server system 302, a registered client device 304, and a nonregistered or “new” client device 306. This particular example assumes that the user is attempting to access a secure destination resource (e.g., a website, a web page, a file transfer site, or the like) using the client device 306, where the user's credentials have not previously been used to access the destination resource with the client device 306. In accordance with the generalized flow shown in FIG. 3, the user enters his credentials (typically a username and password) at the client device 306, which sends the user credentials 310 to the server system 302 for authentication of the user.

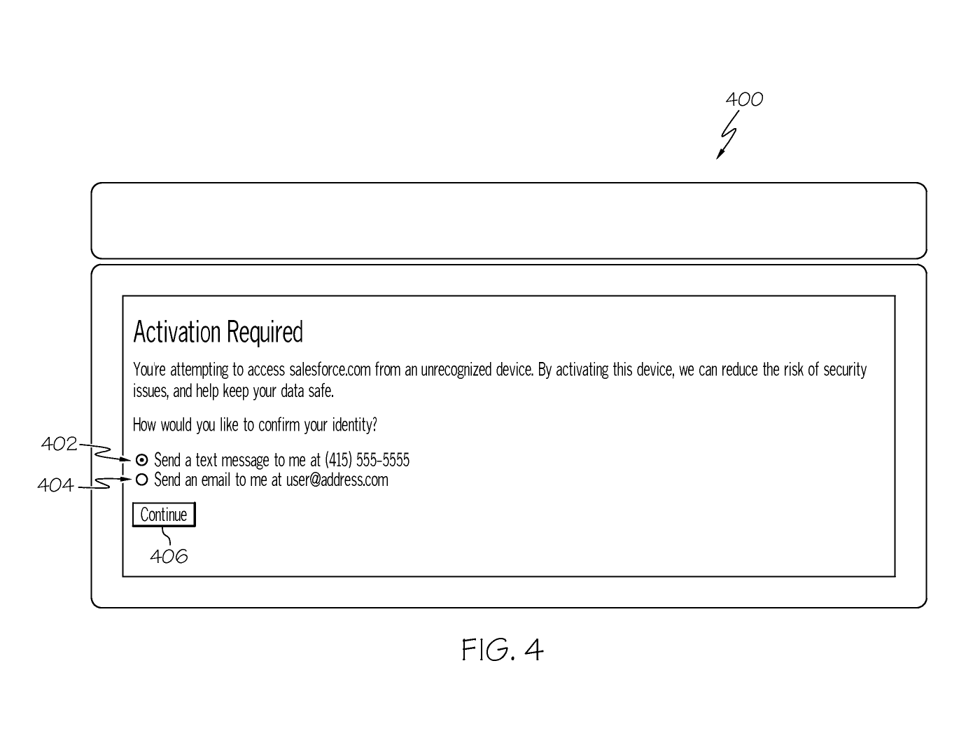

This example assumes that the server system 302 recognizes the user credentials but does not recognize the client device 306 as a currently registered device that is associated with the user credentials. Consequently, the server system 302 generates and provides an appropriate activation screen 312 to the client device 306. In certain embodiments, the activation screen 312 may be provided as a web page or any graphical user interface suitable for display at the client device 306. In this regard, FIG. 4 depicts an exemplary activation screen 400 that may be generated and used as the activation screen 312 during the flow depicted in FIG. 3. The activation screen 400 includes a message that explains that the destination website is being accessed from an unrecognized device, and prompts the user to activate the device.

Notably, the activation screen 400 gives the user the option to select a delivery methodology for carrying out the activation procedure for the new client device 306. The illustrated embodiment allows the user to select at least one telephone number to be used for sending a text message or a voicemail to the user, and at least one email address to be used for sending an email to the user. Although the activation screen 400 provides only one telephone number and only one email address as options, there could be any number of telephone numbers (or no telephone number) and any number of email addresses (or no email address) listed. In practice, a listed telephone number or email address will be one that has already been verified or registered by the system as belonging to the user. In other words, the system trusts that any message sent to a listed email address or telephone number will indeed reach the user who is attempting to access the secure destination resource.

The activation screen 400 may include a user-selectable control 402 that accommodates the selection of the text message option, and a user-selectable control 404 that accommodates the selection of the email option. This particular example assumes that only one message destination can be selected by the user, i.e., either a text message or an email. In other embodiments, the activation screen 400 could allow the user to select multiple options to initiate the sending of a plurality of different messages. The activation screen 400 also includes a user-selectable control 406 (e.g., a “Continue” or “Next” or “Send” button) that is used to initiate the device activation routine. Referring again to FIG. 3, activating the user-selectable control 406 causes the client device 306 to issue an identity confirmation or activation request 314 to the server system 302. For this particular example, the activation request 314 includes information that indicates the user's choice of text messaging as the desired delivery mechanism.

In response to receiving the activation request 314, the server system 302 generates and sends (or, alternatively, initiates the generation and sending by another entity, component, module, or system) at least one message 316 to the user. Notably, the message type or format used at this time will be dictated by the activation request 314. In accordance with this example, therefore, the message 316 will be a text message sent to a device having the designated telephone number (415-555-5555). Depending upon the current situation and operating scenario, a message 316a could be sent to the registered client device 304, a message 316b could be sent to the new client device 306, or both. For this reason, FIG. 3 depicts the message 316 in dashed lines to indicate the different options. The message 316 includes a simple verification code or token (e.g., a short alphanumeric string that is easy to memorize, such as a five-digit number).

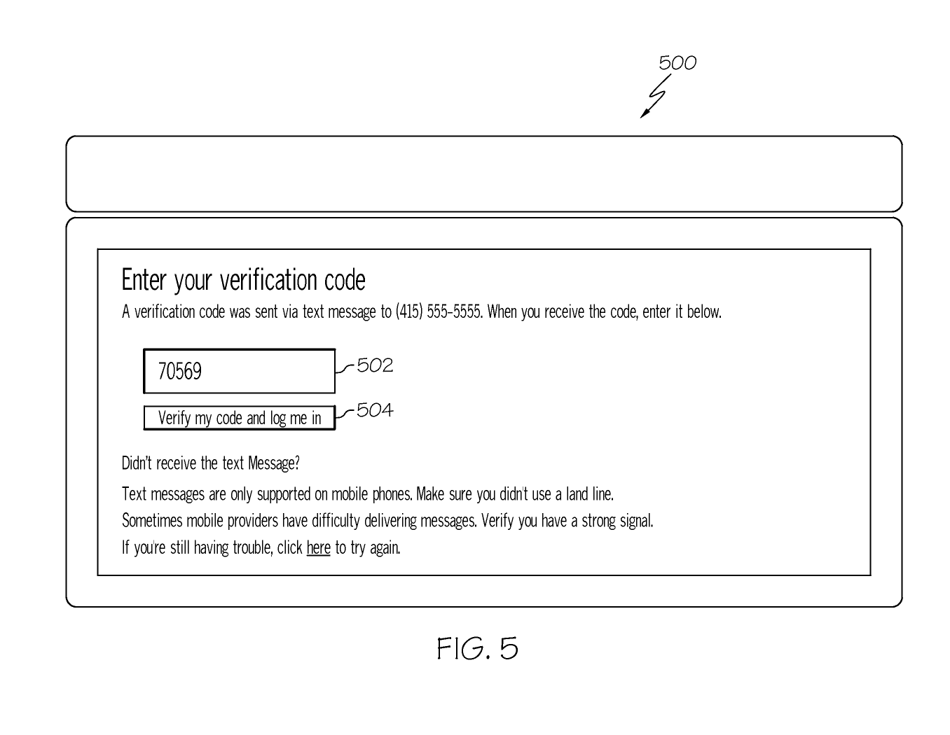

In response to receiving the activation request 314, the server system 302 also generates and provides an appropriate verification screen 318 to the new client device 306. In certain embodiments, the verification screen 318 may be provided as a web page or any graphical user interface suitable for display at the client device 306. In this regard, FIG. 5 depicts an exemplary verification screen 500 that may be generated and used as the verification screen 318 during the flow depicted in FIG. 3. The verification screen 500 informs the user that a verification code was sent using the delivery option chosen by the user at the activation screen 312. For this example, the verification screen 500 informs the user that the code was sent via a text message to the number 415-555-5555. The verification screen 500 also includes instructions for completing activation of the new client device 306 using the code.

This embodiment of the verification screen 500 includes a character entry field 502 to accommodate entry of the received code. In accordance with one typical scenario, the user receives the message 316 at the registered client device 304, views and memorizes the verification code, and then enters the memorized verification code at the character entry field 502. In accordance with another scenario, the user receives the message 316 at the new client device 306, switches from a browser application to an email or text messaging application to obtain the verification code, and switches back to the browser application to enter the memorized verification code at the character entry field 502. Notably, a short, simple, and low complexity verification code should be utilized in this flow to make it easy to memorize. The verification screen 500 also includes a user-selectable control 504 (e.g., a “Verify” or “Continue” or “Next” button) that is used to send the user-entered representation of the verification code to the server system 302. Referring again to FIG. 3, activating the user-selectable control 504 causes the client device 306 to send the user-entered code 320 to the server system 302. The user-entered code 320 originates at the client device that is in need of activation.

The example depicted in FIG. 3 assumes that the user-entered code 320 matches the verification code issued by the server system 302. Accordingly, the server system 302 activates the new client device 306 as a registered device associated with the user credentials, such that subsequent login attempts from the client device 306 are deemed trustworthy. In this regard, the new client device 306 can be added to a list of authorized, trusted, or “white listed” devices corresponding to the user's credentials. Moreover, the server system 302 automatically and seamlessly completes the login procedure in a manner that is transparent to the user. In other words, the user is not prompted to close and restart the browser or any other application, the user is not required to re-enter the user credentials, or the like. Rather, the server system 302 completes the login procedure in the background and seamlessly provides the desired destination resource (web page) 322 to the new client device 306. From the user's perspective, therefore, device activation, identity confirmation, and sign-on are executed in a concurrent one-step manner.

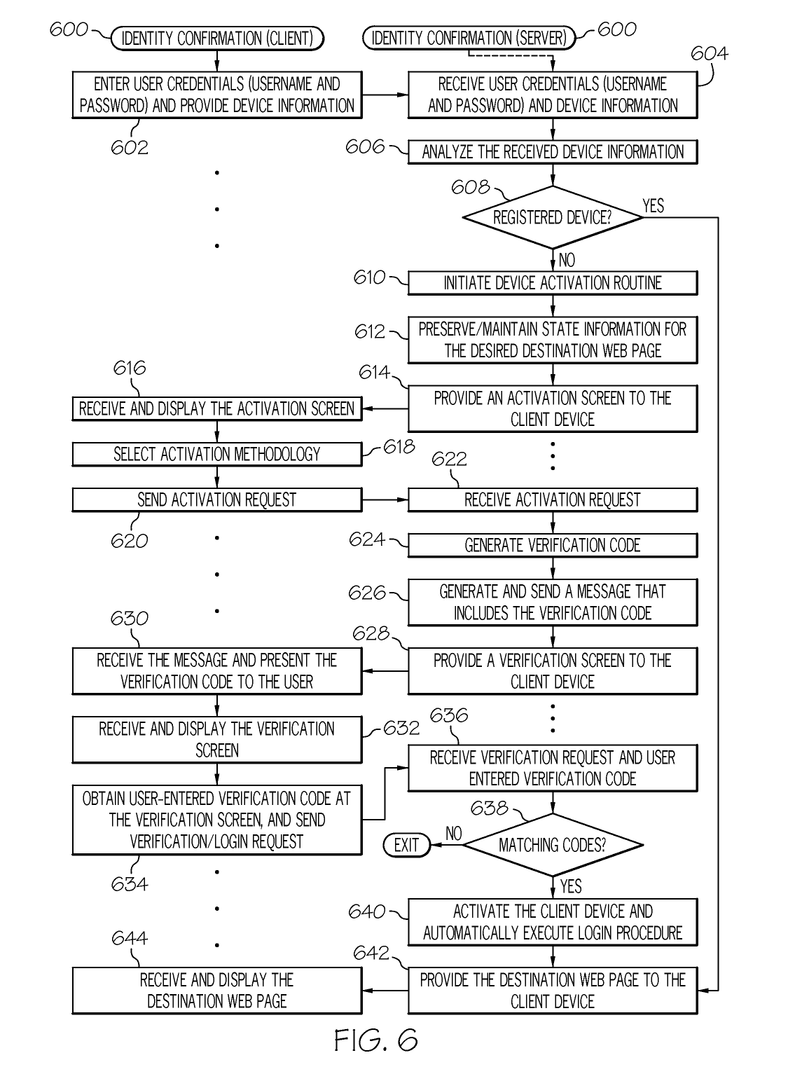

FIG. 6 is a flow chart that illustrates an exemplary embodiment of an identity confirmation process 600. The flow depicted in FIG. 3 may be performed in accordance with the process 600. The various tasks performed in connection with the process 600 may be performed by software, hardware, firmware, or any combination thereof. In other words, the process 600 may represent a computer-implemented method that is executable by a suitably configured client device and/or a suitably configured server system. For illustrative purposes, the following description of the process 600 may refer to elements mentioned above in connection with FIGS. 1-5. In practice, portions of the process 600 may be performed by different elements of the described system, e.g., a server system, a server module, a client device, a client module, or the like. It should be appreciated that the process 600 may include any number of additional or alternative tasks, the tasks shown in FIG. 6 need not be performed in the illustrated order, and the process 600 may be incorporated into a more comprehensive procedure or process having additional functionality not described in detail herein. Moreover, one or more of the tasks shown in FIG. 6 could be omitted from an embodiment of the process 600 as long as the intended overall functionality remains intact.

For this particular embodiment, certain tasks of the process 600 are performed by a client device (for example, any of the client devices 204, 206, 304, 306 mentioned previously), while other tasks are performed by a server system (for example, any of the server systems 102, 202, 302 described previously). Accordingly, the left side of FIG. 6 corresponds to tasks performed by the client device, and the right side of FIG. 6 corresponds to tasks performed by the server system. The process 600 may begin when the client device issues a request (e.g., a login request, a GET request, or the like) to access a secure or otherwise protected destination resource, which may be a website, a web page associated with a secure application, hosted data, or the like. To gain access to the secure destination resource, the user of a client device enters user credentials for purposes of logging into the server system (task 602). In connection with this initial user authentication step, the server system receives and obtains the user credentials for the user (typically a username and password) from the client device (task 604). During task 604 the server system may also obtain certain device information that identifies, describes, or otherwise indicates the client device. In practice, the device information may include, without limitation, an IP address of the client device.

If the user credentials received at task 604 are invalid, then the process 600 may exit or generate an appropriate message to inform the user that the login was unsuccessful. This example assumes that the server system successfully authenticates the user by checking the user credentials and that the process 600 continues in the manner described below. Accordingly, the server system may analyze the received device information (task 606) to determine whether or not the client device is a currently registered, activated, or otherwise recognized device that is associated or linked with the received user credentials. If the client device is already registered with the server system (the “Yes” branch of query task 608), then the majority of the process 600 can be bypassed so that the desired destination resource can be immediately provided to the client device (task 642). If the server system determines that the client device is not a currently registered device (the “No” branch of query task 608), then the server system initiates a device activation routine for the client device (task 610). The device activation routine may also be referred to herein as an identity confirmation routine.

In connection with the process 600, the server system preserves and maintains certain state information corresponding to the destination resource requested by the client device (task 612). In this regard, task 612 may be implemented by saving the URL associated with a requested web page, preserving user-entered data, and the like. In practice, the state information may be preserved whenever device activation is necessary, for reasons that will become apparent from the following description.

In accordance with the device activation routine, the server system may provide a suitably formatted activation screen or page to the client device for display at the client device (task 614). An exemplary activation screen 400 is depicted in FIG. 4, and its features were described above. This example assumes that the client device receives and displays the activation screen (task 616) to enable the user to view and interact with the activation screen. As described above with reference to FIG. 4, the activation screen accommodates a selection of one or more activation methodologies (e.g., text message, email, voicemail, instant messaging). Thus, the client device can be used to select the desired activation methodology (task 618) and to send a suitably formatted activation request (task 620) that includes, indicates, or otherwise conveys the selected activation mode. For the activation screen 400 shown in FIG. 4, the activation request is initiated in response to user interaction with the control 406 (the “Continue” button).

This example assumes that the server system receives the activation request from the client device (task 622), along with the user-selected activation scheme. In response to receiving the activation request, the server system generates a suitably formatted verification code or token having certain properties and characteristics (task 624). In this regard, the server system may cooperate with a security token framework that facilitates the use of a customized and/or configurable format for the verification code. For example, the security token framework may allow a system administrator to specify that verification codes generated by the server system must be of a certain designated length, e.g., less than ten characters long. As another example, the security token framework may allow a system administrator to specify that verification codes generated by the server system must include only numbers, must include a combination of numbers and letters, must be case sensitive, or the like. Moreover, the security token framework may allow a system administrator to designate the valid lifespan for a verification code, to designate a maximum number of “failed attempts” before terminating the device activation routine, and/or configure other safety measures associated with the use of the verification codes.

Next, the server system generates and sends at least one message that includes, indicates, provides access to, or otherwise conveys the verification code (task 626). In contrast to conventional identity challenge protocols, the process does not send an activation link to the client device; the simple verification code is sent in lieu of an activation link. Thus, the user need not copy and paste or manually enter the URL of an activation link in order to activate the client device.

In preferred embodiments, the server system will send the verification code to one or more registered devices of the user. More specifically, the server system will send the message (which conveys the verification code) to the registered user device associated with the selected delivery methodology. Thus, the server system may send an email, a text message, an instant message, a voicemail, or any suitably formatted message that includes or conveys the verification code to the designated client device. Alternatively (or additionally), the server system may initiate the sending of the message by a third party device, system, service, component, or module. For this particular non-limiting example, the designated client device that actually receives the message may be the new client device from which the user is attempting to log in (see FIG. 3 and the accompanying description of the message 316). In practice, however, the verification code need not be sent to the new client machine. Instead, the verification code could be sent to a mobile device or via an email that can be accessed and retrieved anywhere by the user.

The server system may also provide a suitably formatted verification screen or web page to the client device for display at the client device (task 628). An exemplary verification screen 500 is depicted in FIG. 5, and its features were described above. This example assumes that the client device receives the message and presents the verification code to the user in the desired manner, e.g., by displaying the code (task 630). This example also assumes that the client device receives and displays the verification screen (task 632) to enable the user to view and interact with the verification screen. It should be appreciated that the verification screen and the message may be presented on the same client device (i.e., the device being activated) or on two different client devices.

As described above with reference to FIG. 5, the verification screen accommodates user entry of the received verification code. Accordingly, the client device can obtain a user-entered verification code at the verification screen and thereafter send a verification/login request that includes, indicates, or otherwise conveys the user-entered representation of the verification code (task 634). For the verification screen 500 shown in FIG. 5, the verification request is initiated in response to user interaction with the control 504 (the “Verify” button).

In a web-based implementation, the verification screen 500 has a corresponding URL. The server system can implement a security feature that contemplates the “theft” of this URL by an illegitimate user who thereafter attempts to guess the verification code. For instance, if the verification screen 500 is accidentally left displayed in the user's browser when the user steps away from the client device, another person could copy the URL, enter the copied URL into a browser of a different device, and try to guess the verification code. To protect the system against this type of scenario, the URL of the verification screen may have a limited active lifespan associated therewith. For example, the URL of the verification screen may only be valid for twelve hours. If the user fails to enter a good verification code within that time period, the verification routine will time out, forcing the user to initiate the procedure again.

This example assumes that the server system receives the verification request from the client device (task 636), along with the user-entered representation of the verification code. In response to receiving the verification request, the server system compares the user-entered code to the code that was generated by the server system during task 624. If the codes do not match (the “No” branch of query task 638), then the process 600 may exit, generate an appropriate message to inform the user that the user-entered verification code is invalid, prompt the user to re-enter the code, or the like. In certain embodiments, if the codes do not match, then the process 600 gives the user an opportunity to request redelivery of the verification code, and the user may again be allowed to choose the desired delivery mechanism for the verification code, as described previously. If the codes match (the “Yes” branch of query task 638), then the server system activates the client device as a new registered device for the user, as associated with the entered user credentials (task 640). In conjunction with the device activation and identity confirmation, the server system automatically and transparently executes a login procedure and seamlessly provides the intended destination resource to the newly registered client device (task 642). Notably, the seamless transition from “unrecognized device” to registered and logged in device is accomplished using the preserved and maintained state information that corresponds to the originally requested resource (see above description of task 612). All of this activity occurs in the background and transparently to the user. In accordance with a successful verification, therefore, after initiating the verification request at task 634, the client device automatically and quickly receives and displays the destination web page (task 644) without having to initiate or perform any additional user authentication protocols, without having to close and restart the browser application, and without having to access any intervening web pages or sites.

In certain embodiments, the server system need not return the user to another login page. Instead, the server system generates a suitably configured security token from the verification code, and that security token is used internally to authenticate the user of the newly activated/registered client device. In practice, the security token serves as a temporary replacement of the user credentials that were entered by the user at task 602. Notably, the security token generated from the verification code is intentionally created as a short term, temporary, single-use security token. These properties and characteristics of the security token are intended to enhance the security of the system. In practice, the verification code may serve as a seed value for an appropriate token generation algorithm that is designed to generate the security token based on certain rules to ensure that the resulting security token satisfies certain predetermined properties and characteristics.

The security token framework described above may also be used to define a customized and/or configurable format for the security token. For example, the security token framework may allow a system administrator to specify that security tokens generated by the server system must be of a certain designated length, e.g., more than a hundred characters long. Indeed, preferred embodiments utilize relatively complex and high entropy security tokens having 160 characters. As another example, the security token framework may allow a system administrator to specify that security tokens generated by the server system may only be used one time before being discarded.

In accordance with traditional approaches, in order to protect users when their login credentials are stolen (via phishing attacks, etc.), a system can enforce an identity confirmation feature which forces the activation of any device from which a user hasn't successfully logged in before. The problem with traditional ways to implement this feature is that the identity confirmation procedure becomes very disruptive for the user, as upon completing the identity confirmation challenge process, the user may lose all context of where he was headed and have to log in again into the system.

In the exemplary implementation described above, a new identity confirmation scheme removes the problematic user disruption by providing a single sign-on mechanism once the user successfully completes an identity confirmation challenge. The system preserves state information (e.g., which page or resource the user was going to access within the system) before they received the identity challenge. Once the identity confirmation and single sign-on steps are complete, the user is routed to the requested page automatically, seamlessly, and in a transparent manner.

In one embodiment, the user does not have to re-enter his credentials or re-specify his desired destination. Instead, everything is seamlessly taken care of by the system. In certain implementations, the system achieves identity confirmation and single sign-on using two kinds of security tokens. In one implementation, the system introduces timestamp based validation of the identity confirmation URLs so that stolen URLs cannot be leveraged after a threshold lifetime (e.g., twelve hours).

Previous identity confirmation processes employed an activation link emailed to the user. These traditional processes did not have single sign-on capabilities and “dead ended” a user after they clicked on the activation link they received and completed the identity confirmation process. The user would then have to go back to the system login page and re-login. This workflow was especially painful when using mobile applications having embedded browsers and an OAuth flow, which often was terminated during the identity confirmation process. The user would then have to figure out that they needed to terminate and re-launch the mobile application and login again to the system in the mobile application. In other words, there was no timestamp based validation of most identity confirmation URLs, which made them susceptible to abuse if stolen.

In accordance with one exemplary implementation, a methodology allows for a secure and seamless identity confirmation flow that challenges users when they access the system from an unknown device. The system can use security tokens to verify the user's identity and to perform single sign-on for the user, all while preserving the user's transaction (e.g., the desired destination resource that requires user authentication for access).

One feature of the exemplary system embodiment is the ability to provide single sign-on and to avoid the requirement for the user to have to manually re-authenticate. Another beneficial feature is that the system thwarts URL theft attacks by implementing time-limited URLs where needed. The system makes it extremely easy for the user to complete the identity confirmation process on a device on which they don't have access to their email or SMS (text messages), because the system uses a short and simple verification code that can be easily memorized, even when read on another device. Moreover, the system preserves state of where the user was headed, allowing for seamless identity confirmation in complex OAuth application scenarios.

As mentioned above, an exemplary embodiment of the system architecture may utilize a security token framework that introduces a token referred to as a “security token” that may be used for a variety of purposes such as identity confirmation challenge verification, phone verification, single sign-on, and the like. Notably, the security token can be highly configurable and, in one or more embodiments, vary in length, case sensitivity, the kinds of characters it contains (letters, numerals, special characters, etc.), lifetime, etc. In one implementation, the system can revoke a security token after a configured number of failed attempts by the user to enter such a security token. In addition, the system may implement rate limits that limit the maximum number of unique security tokens that can be generated per hour (or per any designated time period). Basically, the security token framework handles generation, verification, rate limiting, and revocation of security tokens.

An exemplary embodiment of the system architecture presented herein accomplishes identity confirmation using a simple verification code. In this regard, a verification code is a type of security token that the system hands out to the user via their previously registered email address or SMS number (on a pre-registered and verified phone or other mobile device). If the user successfully enters a correct verification code when prompted to do so, the identity confirmation process is deemed complete and the user's IP address is registered for access to the system. In addition, the system may place a cookie on the browser of the user device that also serves to bless the device for access to that user's system account.

An exemplary embodiment of the system architecture presented herein implements a single sign-on mechanism to log the user in after they complete the identity confirmation process successfully. In order to do so, the system includes a very long, high entropy, extremely short lived, one time use security token which the system can employ to log the user in. This complex security token acts as a replacement for the user's password. In practice, the complex security token may actually be more secure than a typical password (due to its properties described above). Once the user obtains single sign-on status, the system can discard the temporary security token so that it cannot be reused. The system captures and propagates the state of where (e.g., which web page or HTML document) the user was headed to when they were challenged to confirm their identity. At the point of successful identity confirmation, the system redirects the user to the designation page or resource. This allows users to successfully complete complex flows like OAuth for mobile applications in one single smooth flowing sequence without disruptions and without the need to start over.

An exemplary embodiment of the system architecture presented herein provides for identity confirmation URL theft protection. In this regard, anyone who steals a user's identity confirmation challenge URL can try to guess the user's verification code in an attempt to illegitimately gain access to the user's system account. To mitigate this risk, the system include a timestamp in all identity confirmation URLs; the timestamp can be checked on subsequent URL requests associated with user verification. If the timestamp is older than a threshold, the system rejects the request.

In other embodiments, a number of additional and/or different features may be included. For example, further enhancements can be made to the single sign-on and identity confirmation system. In one or more embodiments, a framework for sending SMS and voice messages to a mobile number may be added, a means to verify mobile numbers in the application may be provided, the ability to use a verified phone number to complete identity confirmation challenges may be added, and/or the ability for a device without corporate email access to complete the identity confirmation challenge may be provided.

In one embodiment, a further feature of the system includes a standardized framework for making callouts to a third party verification service to send either SMS messages or voice messages. The third party should provide an API for this capability. Depending on the method (SMS or voice), the framework may send different information, such as a text string with the localized SMS message, or a text string containing a numeric PIN to send to the user. The framework may be built in a generic manner, such that different “provider” classes can be implemented, allowing the system to easily switch between providers. It also provides the ability to select different providers based on various criteria, such as country code (United States versus Mexico, for example) or transport (SMS versus voice).

Moreover, the system may provide a user interface flow for users to verify a mobile number. For example, the system can provide a field for users to add mobile numbers to their personal information, which other users in their organization can view. A user in an organization with this permission, on login, will see a new UI flow, explaining that they can verify a mobile number for use with various security features. If a user already had a mobile number that was not verified, they are asked to confirm their mobile number. Otherwise, they are asked to enter their mobile number.

Users have the option to continue in the flow later (if they want to use the feature but don't have time right now), or not use it at all, in which case the system will not show the flow on subsequent logins. Users that continue in the flow will get an SMS message with a PIN. They can enter this PIN in the flow to confirm their mobile number is valid.

The system notes which users have verified mobile numbers, and can present additional options to them based on that. Users are also able to re-enter the flow later through their user information page to change a verified mobile number. Making any changes to the number outside of the flow will clear the verified status, and the user may be prompted again on next login to verify the new number.

The system can use the components described above to build a new identity confirmation flow. For example, the flow may send a PIN to the user instead of a link that they must click. The flow also supports sending the PIN to a verified phone via SMS, in addition to a traditional email option.

When a user is challenged, they are presented with a new selection page. If that user has a verified mobile number, they can choose to have the PIN delivered either via email or SMS. If they don't have a verified mobile number, then they are not presented with an option, and instead are simply prompted with a button to send a PIN to their email. In either case, the user is then prompted to enter the PIN (sent either to their email or phone via SMS) to verify their identity. If they enter the correct PIN, the system considers the identity confirmation procedure to be complete and continues in the usual manner (marking their IP address as authorized in the system and setting a cookie so that the browser is also authorized). Another difference with traditional identity confirmation flows is that the system can present the user with the page for PIN input on login, if they already sent themselves a PIN.

The primary benefit is that users on mobile devices without access to corporate email can now complete an identity challenge flow in a quick and easy manner. Previously, those users would not have been able to directly log into a secure resource (e.g., a cloud-based application) on a mobile device, since they would have no way to click an emailed link on the desired device. Using the exemplary system described herein, mobile device users can either send the PIN to the phone directly via SMS, or send themselves an email and obtain the PIN, which can be entered into the phone. Both methods allow verification of the mobile device and allow the users to gain access to a secure destination resource on the newly-activated device. This new scheme also largely resolves issues with users copy-pasting the link incorrectly, leaving off vital portions or adding other portions.

The seamless sign-on methodology represents an improvement on an identity confirmation routine, which provides a layer of protection against phishing attacks (thus, even if someone obtains a user's username and password, they wouldn't be able to get access to the protected application or resource). The techniques and technology described herein builds upon traditional identity confirmation routines and allow identity confirmation on mobile devices, where such confirmation may not have previously been possible. As a result, organizations with heavy mobile device usage no longer have to disable the identity confirmation feature and lower their organization's protection. Instead, users are able to complete identity confirmation challenges on mobile devices using SMS or complete a challenge by checking their email on a device other than the mobile device (such as their corporate laptop).

The foregoing detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, or detailed description.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In this regard, it should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A computer-implemented method executable by a server system to confirm the identity of a user of a client device, the method comprising:
receiving, at the server system, an activation request from the client device;
maintaining information corresponding to a destination resource requested by the client device;
in response to receiving the activation request, sending a code to a registered device of the user;
after sending the code, receiving, at the server system, a verification request from the client device, the verification request including a user-entered representation of the code; and
in response to receiving the verification request, activating the client device as a new registered device for the user and seamlessly providing the destination resource to the client device using the maintained information.

2. The method of claim 1, further comprising:
obtaining, at the server system, user credentials from the client device and device information that identifies the client device;
analyzing the device information at the server system to determine that the client device is not a currently registered device associated with the user credentials; and
initiating, at the server system, a device activation routine for the client device, wherein receiving the activation request from the client device occurs after initiating the device activation routine.

3. The method of claim 2, wherein the device activation routine comprises:
providing an activation screen to the client device for display at the client device, wherein the activation request is initiated at the activation screen.

4. The method of claim 2, wherein the device activation routine comprises:
receiving, at the server system, instructions to send a text message to a designated device, wherein the code is sent to the designated device in the text message.

5. The method of claim 4, wherein the designated device is the client device and the code is sent to the client device in the text message.

6. The method of claim 1, further comprising:
providing a verification screen to the client device for display at the client device, wherein the verification request is initiated at the verification screen.

7. The method of claim 6, wherein the verification screen comprises a character entry field to accommodate entry of the code.

8. The method of claim 1, wherein the code is less than ten characters long.

9. The method of claim 1, further comprising:
generating, at the server system, a single-use security token from the code; and
automatically executing a login procedure at the server system using the single-use security token to authenticate the user of the client device, wherein providing the destination resource to the client device is performed in response to automatically executing the login procedure.

10. The method of claim 9, wherein automatically executing the login procedure occurs in a manner that is transparent to the user.

11. A computer-implemented method executable by a server system to confirm the identity of a user of a client device, the method comprising:
obtaining user credentials for the user, device information that identifies the client device, and a request to access a destination resource;
analyzing the device information to determine that the client device is not a currently registered device associated with the user credentials;
in response to determining that the client device is not a currently registered device associated with the user credentials, preserving state information corresponding to the request to access the destination resource;
in response to determining that the client device is not a currently registered device associated with the user credentials, sending a code from the server system to the client device;
thereafter, the server system receiving a verification request from the client device, the verification request including a user-entered representation of the code; and
in response to receiving the verification request, activating the client device as a new registered device for the user and seamlessly providing the destination resource to the client device using the preserved state information.

12. The method of claim 11, wherein the destination resource comprises a web page associated with a secure application.

13. The method of claim 11, wherein the client device is a mobile device.

14. The method of claim 11, wherein sending the code comprises sending an email that includes the code.

15. The method of claim 11, wherein sending the code comprises sending a text message that includes the code.

16. The method of claim 11, further comprising:
generating a temporary security token from the code; and
automatically executing a login procedure using the temporary security token to authenticate the user of the client device, wherein providing the destination resource to the client device is performed in response to automatically executing the login procedure.

17. A server system to confirm the identity of a user of a client device, the server system comprising:
a device activation module configured to activate the client device for the user, in response to receiving a login request for access to a destination resource, by sending a code to a registered device of the user, and thereafter receiving a user-entered representation of the code from the client device; and
an authentication module configured to generate a temporary single-use security token in response to receiving the user-entered representation of the code, authenticate the user of the client device using the temporary single-use security token, and automatically provide the destination resource to the client device after authenticating the user of the client device.

18. The server system of claim 17, wherein the device activation module is configured to send the code to the registered device of the user in the form of a text message.

19. The server system of claim 17, wherein the authentication module automatically provides the destination resource to the client device in a seamless manner that is transparent to the user.

20. The server system of claim 17, wherein the device activation module obtains user credentials for the user and device information that identifies the client device, analyzes the device information to determine that the client device is not a currently registered device associated with the user credentials, and sends the code to the registered device of the user in response to determining that the client device is not a currently registered device associated with the user credentials.
